(19) United States
(12) Patent Application Publication
(10) Pub. No.: US 2026/0036876 A1
(43) Pub. Date: Feb. 5, 2026

(54) VARIABLE APERTURE, LENS MODULE, AND ELECTRONIC DEVICE

(71) Applicant: Guangzhou Luxvisions Innovation Technology Limited, Guangdong (CN)

(72) Inventors: Junjie LIN, Guangdong (CN); Tsungkai CHANG, Guangdong (CN)

(73) Assignee: Guangzhou Luxvisions Innovation Technology Limited, Guangdong (CN)

(21) Appl. No.: 19/203,703

(22) Filed: May 9, 2025

(30) Foreign Application Priority Data
Aug. 5, 2024 (CN) 202411065712.1

(51) Int. Cl. G03B 9/06; G03B 30/00

(52) U.S. Cl. CPC G03B 9/06; G03B 30/00

(57) ABSTRACT

A variable aperture, a lens module and an electronic device are provided. The variable aperture includes a fixed seat, a movable seat, a driving mechanism, a blade group and a retention assembly. The fixed seat has a mounting space and is provided with a limiting portion along the optical axis direction. The movable seat, driving mechanism and blade group are located in the mounting space, the blade group can rotate around the optical axis following the movable seat to adjust size of light inlet. The variable aperture allows movable seat to be attracted to the fixed seat by the magnetic attraction force possessed by the retention assembly, and the blade group rests against the limiting portion of the fixed seat. When the variable aperture is not electrified, movement of the blade group can be restricted, thereby and blade group cannot move freely under external forces.

### CROSS-REFERENCE TO RELATED APPLICATION

The application claims priority to Chinese patent application CN 202411065712.1, filed on Aug. 5, 2025, the entire contents of which are incorporated herein by reference for all purposes.

### FIELD

This application relates to the field of optical equipment, and particularly to a variable aperture, lens module, and electronic device.

### BACKGROUND

In related technologies, some types of lens modules have apertures with variable light inlet sizes. The size of the light inlet is mainly controlled by the convergence or dispersion of the aperture blades to control the size of the exposed light inlet, thereby achieving adjustable size of the light inlet.

The convergence or dispersion of aperture blades is usually achieved by driving the blades through the driving mechanism in the aperture being energized. In the event of a power failure, the driving mechanism cannot control the convergence or dispersion of the aperture blades, the aperture blades can move freely in the aperture under external forces, which may cause abnormal noise in the aperture.

### SUMMARY

The present embodiments disclose a variable aperture, lens module and electronic device that can fix the blade group in the event of power failure, thereby reducing the occurrence of abnormal noise in the aperture.

In order to achieve the above objectives, the present application discloses a variable aperture, comprising:
a fixed seat, the fixed seat having a mounting space with an opening along an optical axis direction, the fixed seat being provided with a limiting portion along the optical axis direction, the limiting portion being located outside the mounting space to block at least a portion of a first opening of the mounting space;
a movable seat, the movable seat being provided movably in the mounting space, and the movable seat being provided with a light inlet along the optical axis direction;
a driving mechanism, the driving mechanism being provided at the fixed seat, and the driving mechanism being connected to the movable seat, the driving mechanism being configured to take the movable seat to rotate around the optical axis direction;
a blade group, the blade group being provided at one end of the movable seat towards the limiting portion and located in the mounting space, the blade group being configured to rotate around the optical axis direction following the movable seat, so that the blade group exposes or blocks at least a part of the light inlet to adjust the size of the light inlet; and a retention assembly, the retention assembly comprising a first magnetic member and a second magnetic member, one of the first magnetic member and the second magnetic member being provided at the fixed seat, and the other of the two being provided at the movable seat, the first magnetic member and the second magnetic member being configured to magnetically connect the movable seat along the optical axis direction to the fixed seat, so that the blade group rests against the limiting portion.

As an optional implementation, the variable aperture comprises a reset assembly, the reset assembly is provided in the mounting space, and the reset assembly is configured to drive the movable seat to reset relative to the fixed seat along the optical axis direction when energized, so that the blade group moves away from the limiting portion along the optical axis direction.

As an optional implementation, the reset assembly comprises an electromagnetic coil and a third magnetic member, the electromagnetic coil is provided at the fixed seat, the third magnetic member is provided at the movable seat, and the electromagnetic coil is configured to generate a magnetic field when energized so that the third magnetic member responds to the acting force of the magnetic field to take the movable seat to reset relative to the fixed seat along the optical axis direction.

As an optional implementation, the electromagnetic coil is provided on a surface of the fixed seat along a first direction, the third magnetic member is provided on a surface of the movable seat along the first direction, and the third magnetic member is provided corresponding at least partially to the electromagnetic coil.

The first direction is perpendicular to the optical axis direction.

As an optional implementation, the retention assembly is multiple groups, and multiple groups of the retention assembly are spaced separately around the optical axis of the variable aperture.

As an optional implementation, the driving mechanism comprises a first mounting member, a second mounting member and a shape memory alloy wire, the first mounting member is provided at the fixed seat, the second mounting member is provided at the movable seat, the shape memory alloy wire connects the first mounting member to the second mounting member, and the shape memory alloy wire is configured to deform in response to temperature changes to take the movable seat to rotate around the optical axis direction.

As an optional implementation, the fixed seat comprises a cover plate and a base, the cover plate is connected to the base and located outside the mounting space along the optical axis direction, the cover plate is formed as the limiting portion, and a second opening corresponding to and communicating with the light inlet is provided on the cover plate.

As an optional implementation, the variable aperture comprises a sensor, the sensor is provided in the mounting space, and the sensor is configured to detect the rotational position of the movable seat relative to the fixed seat; and

the variable aperture comprises a housing and a flexible circuit board, the housing is provided on the outer peripheral surface of the fixed seat, the flexible circuit board is provided between the housing and the fixed seat, the sensor and the driving mechanism are electrically connected to the flexible circuit board, and the flexible circuit board is configured to be electrically connected to an electric circuit.

In a second aspect, the present application further discloses a lens module comprising a lens body and the variable aperture as described in the first aspect, and the variable aperture is connected to the lens body along the optical axis direction.

In a third aspect, the present application further discloses an electronic device comprising the lens module as described in the second aspect.

The beneficial effect of the present application compared to the prior art is as follows:

The present application discloses a variable aperture, a lens module and an electronic device, wherein the variable aperture comprises a fixed seat, a movable seat, a drive mechanism, a blade group and a retention assembly. The fixed seat has a mounting space, and the fixed seat is provided with a limiting portion along an optical axis direction. The movable seat, the driving mechanism and the blade group are all located in the mounting space, and the blade group can rotate around the optical axis direction following the movable seat to achieve the adjustment of the size of the light inlet. At the same time, the variable aperture of the present application is also provided with a retention assembly, the retention assembly including a first magnetic member and a second magnetic member. By cooperatively connecting the first magnetic member and the second magnetic member, the movable seat is magnetically connected to the fixed seat, so as to keep the blade group rest against the limiting portion. As can be seen, the present application provides the retention assembly and uses the magnetic attraction of the retention assembly to make the movable seat be magnetically attracted to the fixed seat, so that the blade group is correspondingly rested against the limiting portion of the fixed seat. In this way, even when the variable aperture is not energized, it is possible to restrict the movement of the blade group, thereby reducing the chance that the blade group will move randomly under the action of an external force and produce abnormal noise. In addition, by adopting the solutions of the present application, it is possible to fix the blades without energizing the variable aperture, which is conducive to reducing the power loss of the electronic device.

### BRIEF DESCRIPTION OF THE DRAWINGS

In order to more clearly illustrate the technical solutions in the embodiments of the present application, the accompanying drawings to be used in the embodiments will be briefly introduced below, and it will be obvious that the accompanying drawings in the following description are only some of the embodiments of the present application, and that for a person of ordinary skill in the art, other accompanying drawings can be obtained based on these drawings without putting in any creative efforts.

FIG. 1 shows a schematic diagram of a first structure of a variable aperture disclosed in an embodiment of the present application;

FIG. 2 shows a sectional view taken along A-A in FIG. 1;

FIG. 3 shows a schematic view of the structure of the movable seat disclosed in the embodiments of the present application;

FIG. 4 shows a sectional view taken along B-B in FIG. 1;

FIG. 5 shows a schematic diagram of a second structure of the variable aperture disclosed in embodiments of the present application;

FIG. 6 shows a schematic diagram of a third structure of the variable aperture disclosed in embodiments of the present application;

FIG. 7 shows a schematic diagram of a lens module disclosed in embodiments of the present application; and

FIG. 8 shows a schematic diagram of an electronic device disclosed in embodiments of the present application.

Description of the reference numbers:
100, variable aperture; 1, fixed seat; 1a, auxiliary rotation structure; 1b, groove; 11, limiting portion (cover plate); 11a, second opening; 12, base; 2, movable seat; 2a, light inlet; 3, driving mechanism; 31, first mounting member; 32, second mounting member; 33, shape memory alloy wire; 4, blade group; 5, retention assembly; 51, first magnetic member; 52, second magnetic member; 6, reset assembly; 61, electromagnetic coil; 62, third magnetic member; 7, sensor; 8, housing; 9, flexible circuit board; 200, lens module; 201, lens body; 300, electronic device.

### DETAILED DESCRIPTION OF EMBODIMENTS

The technical solutions in the embodiments of the present application will be described clearly and completely in the following in conjunction with the accompanying drawings in the embodiments of the present application, and it is obvious that the described embodiments are only a part of the embodiments of the present application and not all of the embodiments. Based on the embodiments in this application, all other embodiments obtained by a person of ordinary skill in the art without making creative efforts fall within the scope of protection of this application.

In this application, the terms “on”, “below”, “top”, “bottom”, “inside”, “outside”, “in” and the like indicate an orientation or positional relationship based on the orientation or positional relationship shown in the accompanying drawings. These terms are primarily intended to better describe the present application and its embodiments, and are not intended to define that the indicated device, element or component must have a particular orientation, or be constructed and operated in a particular orientation.

Moreover, some of the above terms may be used to indicate other meanings in addition to the orientation or positional relationship, for example, the term “on” may also be used to indicate a certain dependency or connection relationship in some cases. To a person of ordinary skill in the art, the specific meaning of these terms in the present application may be understood on a case-by-case basis.

In addition, the terms ‘mounted’, ‘disposed’, ‘provided’ and ‘connected’ are to be understood broadly. For example, it may be a fixed connection, a removable connection or a monolithic construction; it may be a mechanical connection or an electrical connection; it may be a direct connection or an indirect connection through an intermediate medium; or it may be an internal communication between two devices, elements or components. To a person of ordinary skill in the art, the specific meaning of the above terms in the present application may be understood according to the specific circumstances.

In addition, the terms “first”, “second”, etc. are mainly used to distinguish different devices, elements or components (the specific types and configurations may be the same or different), and are not used to indicate or imply the relative importance and number of the indicated devices, elements or components. Unless otherwise indicated, “multiple” means two or more.

The technical solutions of the present application will be further described below in connection with the embodiments and the accompanying drawings.

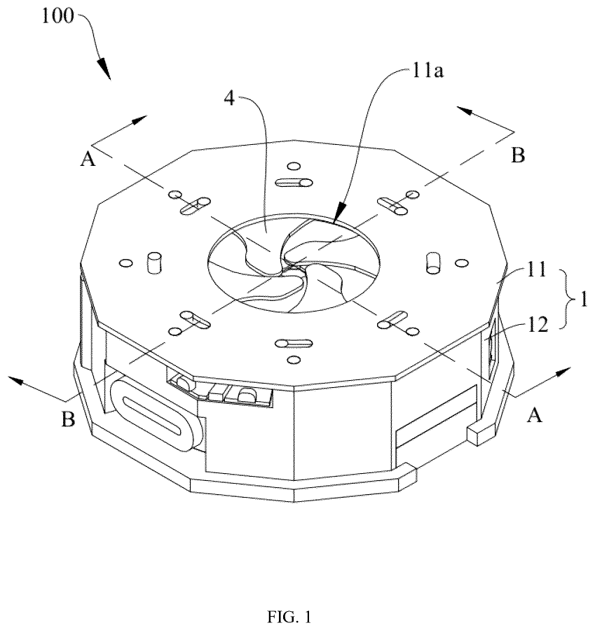

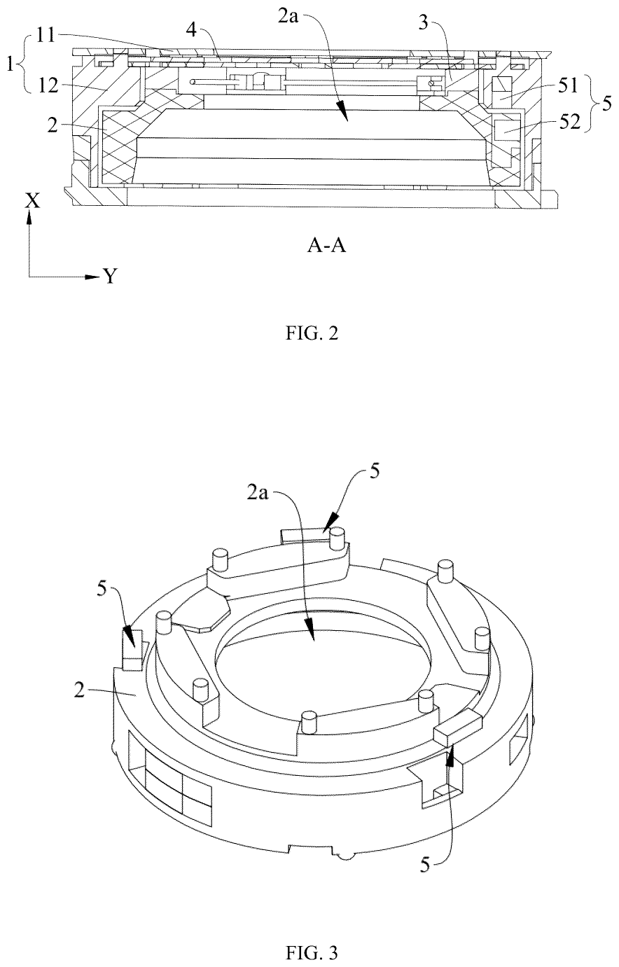

In a first aspect, referring to FIG. 1 and FIG. 2, the present application discloses a variable aperture 100. The variable aperture 100 comprises a fixed seat 1, a movable seat 2, a driving mechanism 3, a blade group 4 and a retention assembly 5. It will be appreciated that the variable aperture 100 typically has an optical axis. The fixed seat 1 has a mounting space (not labelled) opening along the optical axis direction X. The fixed seat 1 is provided with a limiting portion 11 along the optical axis direction. The limiting portion 11 is disposed outside of the mounting space to block at least a part of the first opening (not labelled) of the mounting space. The movable seat 2 is movably disposed in the mounting space. The movable seat 2 is provided with a light inlet 2a along the optical axis direction. The light inlet 2a is communicated to the first opening of the mounting space. The driving mechanism 3 is provided in the fixed seat 1. The driving mechanism 3 is connected to the movable seat 2, and the driving mechanism 3 is used to drive the movable seat 2 to rotate around the optical axis direction. The blade group 4 is provided at an end of the movable seat 2 towards the limiting portion 11 and is located inside the mounting space. The vane group 4 may be rotated around the optical axis direction with the rotation of the movable seat 2, so as to enable the blade group 4 to expose or block at least a part of the light inlet 2a for adjusting the size of the light inlet 2a.

The retention assembly 5 comprises a first magnetic member 51 and a second magnetic member 52. One of the first magnetic member 51 and the second magnetic member 52 is provided in the fixed seat 1, and the other of the two is provided in the movable seat 2. The first magnetic member 51 and the second magnetic member 52 are used to displace the movable seat 2 along the optical axis direction, so as to magnetically connect the movable seat 2 to the fixed seat 1, and to make the movable seat 2 rest against the limiting portion 11, thereby limiting the movement of the blade group 4.

It will be appreciated that there is a magnetic attraction between the two magnetic members. The present application provides one magnetic member in the fixed seat 1 and the other magnetic member in the movable seat 2, for example providing the first magnetic member 51 in the fixed seat 1 and the second magnetic member 52 in the movable seat 2. Since the movable seat 2 is movable, when the first magnetic member 51 attracts the second magnetic member 52, the movable seat 2 is attracted by the first magnetic member 51 under the action of the second magnetic member 52, thereby causing an end portion of the movable seat 2 to rest against the fixed seat 1. At this time, the blade group 4, which is located on the side of the movable seat 2 towards the limit portion 11, is then rested against the limit portion 11. Specifically, the blade group 4 is disposed between the limit portion 11 and the movable seat 2, and when the movable seat 2 is attracted to the fixed seat 1, it is equivalent to the blade group 4 being sandwiched between the movable seat 2 and the limit portion 11, so that the relative positions of the individual blades of the blade group 4 are restricted, thereby rendering the individual blades immobilized. In this way, the variable aperture 100 can clamp the blade group 4 between the movable seat 2 and the limiting portion 11 of the fixed seat 1, by the first magnetic member 51 and the second magnetic member 52 of the retention assembly 5, so that the blade group 4 can keep the relative position of each blade unchanged without being energized, so as to keep the size of the aperture unchanged, and thus reduce the chance of the blade group 4 being moved randomly under the action of external forces, which may cause abnormal noises. In addition, the design of the present application enables the variable aperture 100 to fix the position of the blades even when the variable aperture 100 is not energized, so that there is no need to consume the power of the electronic device equipped with the variable aperture 100, which is conducive to reducing the loss of the power of the electronic device.

In order to enhance the restriction effect on the blade group 4, optionally, the retention assembly 5 may have multiple groups, and each group of retention assembly 5 is spaced apart around the optical axis. For example, it may be two groups, three groups, four groups or five groups, and so on. In the present application, the movable seat 2 is attracted on the fixed seat 1 in the optical axis direction by the multiple groups of retention assemblies 5, so that the movement of the blade group 4 is restricted by the limiting portion 11 to enhance the restricting effect on the movement of the blade group 4. For example, as shown in FIG. 3, the retention assembly 5 is illustrated as three groups, the three groups of retention assemblies 5 are provided in a ring shape along the center of the movable seat 2. Each group of retention assemblies 5 includes the first magnetic member 51 and the second magnetic member 52 as described above, so as to achieve a multi-point restriction of the movable seat 2, which is in turn conducive to improving the restricting effect on the movement of the blade group 4.

Optionally, the fixed seat 1 comprises a cover plate 11 and a base 12. The cover plate 11 is attached to the base 12 and located outside the mounting space along the optical axis direction. The cover plate 11 is formed as the limiting portion 11 for restricting the movement of the vane group 4 when the movable seat 2 is attracted to the fixed seat 1. The cover plate 11 blocks at least a portion of the first opening of the mounting space and leaves a portion of the first opening to form a second opening 11a, which corresponds to and is communicated with the light inlet 2a of the movable seat 2, such that when the variable aperture 100 is in use, light can pass through the second opening 11a through the light inlet 2a along the optical axis. In some examples, the cover plate 11 is removable with respect to the base 12, such that the structures within the mounting space of the variable aperture 100 can be installed, serviced or replaced through the end provided with the cover plate 11, facilitating removal and mounting of the structures. In other examples, the cover plate 11 may also be integrally provided with the base 12, and structures such as the movable seat 2, the blade group 4 and the like may be removable and installed through the end of the base 12 away from the cover plate 11.

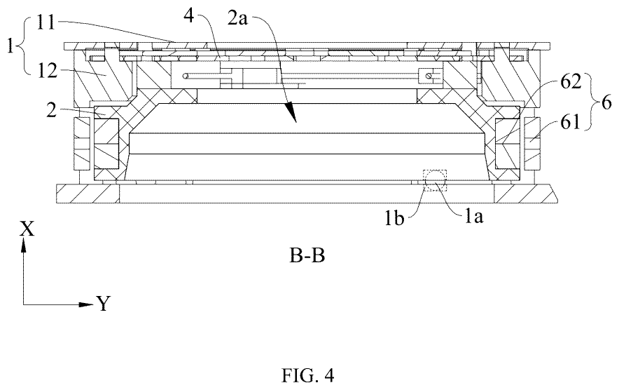

Considering the need to restore the movability of the blade group 4 when the variable aperture 100 is normally energized, referring to FIG. 4, in some embodiments, the variable aperture 100 further comprises a reset assembly 6. The reset assembly 6 is disposed inside the mounting space. The reset assembly 6 is used to drive the movable seat 2 to reset along the optical axis direction relative to the fixed seat 1 when energized, so as to move the blade group 4 away from the limiting portion 11 along the optical axis direction. In other words, in the energized state, the reset assembly 6 is able to counteract, or overcome, the magnetic attraction force between the first magnetic member 51 and the second magnetic member 52, thereby causing the movable seat 2 to restore to its previous position prior to being attracted, and taking the blade group 4 to separate from the limiting portion 11, and then the individual blades of the blade group 4 are able to move relative to each other, so that the blade group 4 is able to rotate along with the rotation of the movable seat 2 in the event that the driving mechanism 3 drives the movable seat 2 to rotate. In this way, the blade group 4 can achieve normal operation in the energized state, avoiding a situation in which the adjustment function of the blade group 4 on the aperture size is affected due to the restriction of the retention assembly 5.

Optionally, the reset assembly 6 comprises an electromagnetic coil 61 and a third magnetic member 62. The electromagnetic coil 61 is disposed at the fixed seat 1 and the third magnetic member 62 is disposed at the movable seat 2. The electromagnetic coil 61 is configured to generate a magnetic field when energized, so as to cause the third magnetic member 62 to take the movable seat 2 to reset in the optical axis direction with respect to the fixed seat 1 in response to the action of the magnetic field force. It will be appreciated that the electromagnetic coil 61 generates the magnetic field in the energized state and the magnetic field disappears in the de-energized state. That is, in the present application, the electromagnetic coil 61 is energized to generate a magnetic field, and a magnetic attraction force on the third magnetic member 62 is generated, thereby counteracting or overcoming the magnetic attraction force of the first magnetic member 51 on the second magnetic member 52, and driving the movable seat 2 away from the limiting portion 11 along the optical axis direction, so that the movable seat 2 restores to the state in which it can be rotated with respect to the fixed seat 1 in order to facilitate the movability of the blade group 4, thereby realizing the adjustment of the size of the aperture.

It will be appreciated that the first magnetic member 51, the second magnetic member 52, and the third magnetic member 62 may all be magnets. Alternatively, the first magnetic member 51 is a magnet, and the second magnetic member 52 and the third magnetic member 62 are metal members with magnetic conductivity. Alternatively, the second magnetic member 52 is a magnet, and the first magnetic member 51 and the third magnetic member 62 are metal members with magnetic conductivity. Or, alternatively, the first magnetic member 51 and the third magnetic member 62 are magnets, while the second magnetic member 52 is a metal member with magnetic conductivity, etc. Specific settings may be made according to the actual situation, and will not be specifically limited in the present embodiment.

Optionally, the electromagnetic coil 61 is provided on the surface of the fixed seat 1 along the first direction Y, the third magnetic member 62 is provided on the surface of the movable seat 2 along the first direction, and the third magnetic member 62 is provided at least partially corresponding to the electromagnetic coil 61. In other words, the third magnetic member 62 may be provided in a misaligned position with the electromagnetic coil 61, or both may be provided completely opposite to each other. In the actual setting, when the movable seat 2 is attracted to the fixed seat 1, a misalignment between the positions of the third magnetic member 62 and the electromagnetic coil 61 is generated. When the electromagnetic coil 61 is energized to generate a magnetic field, the magnetic field of the electromagnetic coil 61 is misaligned with the magnetic field of the third magnetic member 62, such that the resulting magnetic attraction between the both will force the magnetic fields of the both to return to the opposite position, that is, the third magnetic member 62 is disposed in a completely opposite position to the electromagnetic coil 61. In this way, the third magnetic member 62 takes the movable seat 2 to be reset to a position corresponding to the electromagnetic coil 61. Thus, the reset assembly 6 makes the movable seat 2 to move away from the limiting portion 11 in the optical axis direction, so that the movable seat 2 is reset to a position in which it can rotate relatively. When the electromagnetic coil 61 is energized, it not only effectively restores the third magnetic member 62 to a position opposite to the electromagnetic coil 61, but also generates magnetic field damping to avoid the magnetic field of the third magnetic member 62 from deviating too much from the magnetic field of the electromagnetic coil 61 when rotating, so as to prevent the movable seat 2 from moving excessively, which may cause the movable seat 2 to be offset within the mounting space, thereby affecting the normal use of the variable aperture 100.

In some examples, the first direction Y is perpendicular to the optical axis direction X, i.e., the first direction is a radial direction of the optical axis. In the radial direction of the optical axis, the third magnetic member 62 is provided at an outer peripheral wall of the movable seat 2, and the electromagnetic coil 61 is provided at an inner side wall of the fixed seat 1, such that the third magnetic member 62 is provided in correspondence with the electromagnetic coil 61. The outer peripheral wall of the movable seat 2 and the inner side wall of the fixed seat 1 are provided with more space for setting the electromagnetic coil 61 and the third magnetic member 62.

In other examples, the first direction is in the same direction as the optical axis direction, i.e., the axial direction of the optical axis. The third magnetic member 62 is provided at an end of the movable seat 2 along the axial direction of the optical axis and is provided away from the light inlet 2a, and the electromagnetic coil 61 is provided at an end of the fixed seat 1 along the optical axis direction and is provided corresponding to the third magnetic member 62. By aligning the position of the third magnetic member 62 with that of the electromagnetic coil 61, the present application avoids a situation in which the distance between the third magnetic member 62 and the electromagnetic coil 61 is too large, resulting in a magnetic attraction failure.

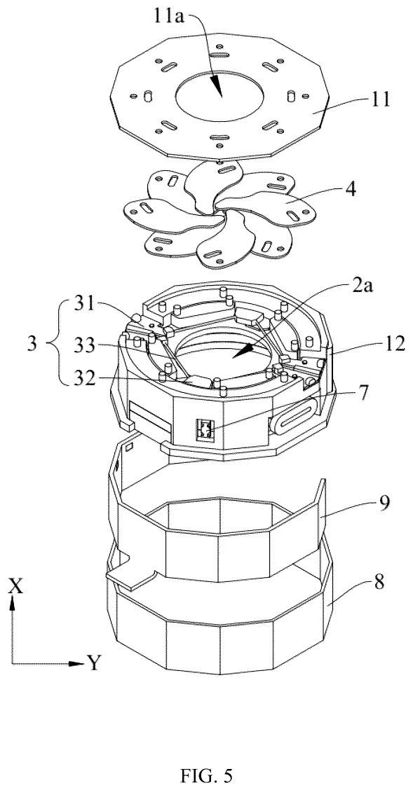

Please refer to FIG. 4 or FIG. 5, where the direction indicated by X is the optical axis direction and the direction indicated by Y is the first direction.

Optionally, the reset assembly 6 can be multiple groups, such as two, three, four, five groups, etc., with each group of reset assembly 6 spaced separately around the optical axis. The present application provides with multiple groups of reset assemblies 6 to enhance their ability to counteract the magnetic attraction generated by the retention assembly 5 on the movable seat 2, so that the reset assemblies 6 can effectively reset the movable seat 2. Moreover, the multiple groups of reset assemblies 6 generate more stable magnetic attraction force when resetting the movable seat 2, preventing displacement during the resetting of the movable seat 2. For example, as shown in FIG. 4, the reset assemblies are provided as two groups, which are symmetrically arranged relative to the center of the optical axis.

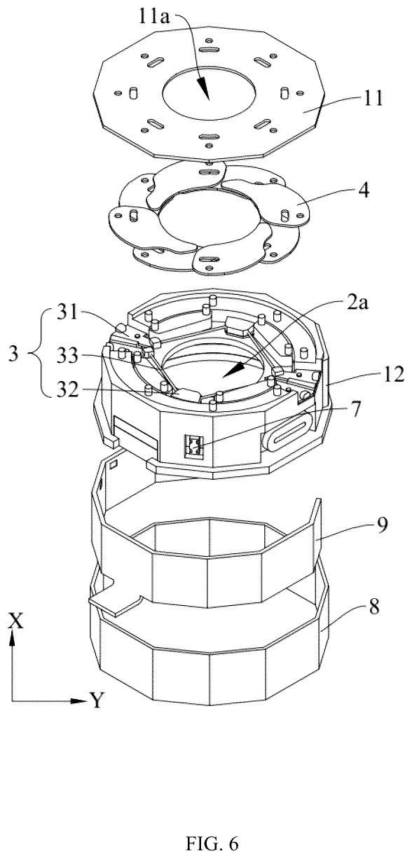

Please refer to FIG. 5 or FIG. 6. In some embodiments, the driving mechanism 3 includes a first mounting member 31, a second mounting member 32, and a shape memory alloy wire 33. The first mounting member 31 is provided at the fixed seat 1, and the second mounting member 32 is provided at the movable seat 2.

The shape memory alloy wire 33 connects the first mounting member 31 and the second mounting member 32. It will be appreciated that shape memory alloy can deform under temperature changes. When the shape memory alloy wire 33 is connected to the circuit of the variable aperture 100 or to the circuit of an electronic device equipped with the variable aperture 100, upon the circuit is connected to the power supply, current flows through the shape memory alloy wire 33, causing it to heat up and deform. The present application utilizes the deformation characteristics of shape memory alloy wire 33 under temperature changes to drive the movable seat 2 to rotate relative to the fixed seat 1. The structure is simple and has a good effect on adjusting the aperture size, which is conducive to the miniaturization design of the variable aperture 100.

In some examples, one end of the shape memory alloy wire 33 is connected to the end of the fixed seat 1 along the optical axis direction, and the other end thereof is connected to the end of the movable seat 2 along the optical axis direction, and the connection direction of the two ends of the shape memory alloy wire 33 is inclined relative to the radial direction of the optical axis. When the shape memory alloy wire 33 deforms, the movable seat 2 is subjected to the tensile force of the deformation of the shape memory alloy wire 33, thereby causing the movable seat 2 to rotate.

In other examples, one end of the shape memory alloy wire 33 is connected to the inner side wall of the fixed seat 1 along the radial direction of the optical axis, and the other end of the shape memory alloy wire 33 is connected to the outer peripheral wall of the movable seat 2 along the radial direction of the optical axis, and the connection direction of the shape memory alloy wire 33 is tangent to the outer peripheral wall of the movable seat 2. When the shape memory alloy wire 33 deforms, it pulls the movable seat 2 to rotate along the tangential direction of the outer peripheral wall of the movable seat 2.

Optionally, the first mounting member 31 and the second mounting member 32 can be, but are not limited to, buckles, metal welding points, bolts, etc., as long as the first mounting member 31 and the second mounting member 32 can be used for fixing the shape memory alloy wire 33 on the fixed seat and the movable seat 2, and the present application does not make specific limitations here.

In other embodiments, the driving mechanism 3 can be a motor, which drives the movable seat to rotate relative to the fixed seat 1, thereby taking the blade group 4 to move so as to adjust the aperture size, which is beneficial for the aperture adjustment of the variable aperture with high sensitivity.

In order to enhance the flexibility of the rotation of the movable seat 2 relative to the fixed seat 1, the variable aperture 100 optionally further comprises an auxiliary rotating structure 1a. The auxiliary rotating structure 1a includes multiple rolling elements. The multiple rolling elements are arranged at one end of the movable seat 2 away from the blade group 4 along the optical axis direction and between the movable seat 2 and the fixed seat 1. Both the fixed seat 1 and the movable seat 2 are provided with a plurality of grooves 1b corresponding to the rolling elements to accommodate the rolling elements.

The present application converts the relative sliding between the movable seat 2 and the fixed seat 1 into relative rolling between the two through the auxiliary rotating structure 1a, reducing the resistance of the movement between the fixed seat 1 and the movable seat 2, thereby improving the sensitivity of aperture size adjustment. In addition, the groove 1b provided in the movable seat 2 and the fixed seat 1 can also limit the rolling distance of the rolling elements. By setting the opening length of the groove 1b, the rolling distance of the rolling elements can be limited, thereby limiting the relative rotation angle between the movable seat 2 and the fixed seat 1, and avoiding excessive rotation of the movable seat 2 and the fixed seat 1 to damage the shape memory alloy wire 33.

Optionally, the rolling elements can be, but are not limited to, ball bearings, rollers, etc., which are not specifically limited in the present application.

In some embodiments, the variable aperture 100 further comprises a sensor 7, which is disposed within the mounting space. The present application sets up a sensor 7 in the fixed seat 1, collects the angle data of the movable seat 2 rotating inside the fixed seat 1 through the sensor 7, and then feeds back the collected data to the electronic device installed with the variable aperture 100 for analysis to determine the size of the aperture adjustment, so that users can understand the size of the aperture adjustment.

Optionally, the sensor 7 can be, but is not limited to, a Hall magnetic sensor, an infrared sensor, etc., which are not specifically limited in the present application.

Optionally, the variable aperture 100 further includes a housing 8 and a flexible circuit board 9. The housing 8 is provided on the outer periphery of the fixed base 1, and the flexible circuit board 9 is provided between the housing 8 and the fixed base 1. The sensor 7, driving mechanism 3 and electromagnetic coil 61 are electrically connected to the flexible circuit board 9, which is configured to be electrically connected to the electric circuit. The present application integrates the circuits inside the variable aperture 100 through a flexible circuit board 9, reducing the occupation of internal space of the variable aperture 100 and yielding the retention assembly 5, reset assembly 6 and driving mechanism 3. In addition, the housing 8 can protect the flexible circuit board 9 from damage.

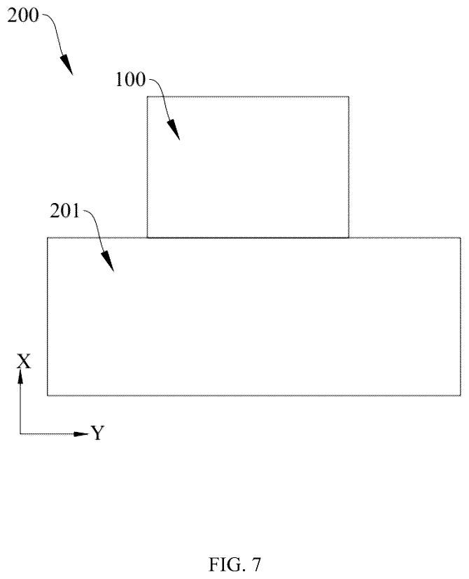

In a second aspect, please refer to FIG. 7, the present application also discloses a lens module 200. The lens module 200 includes a lens body 201 and the variable aperture 100 as disclosed in the first aspect. The variable aperture 100 is connected to the lens body 201 along the optical axis direction X. Specifically, along the optical axis direction X, the lens body is positioned behind the variable aperture, meaning that light enters the variable aperture 100 before entering the lens body 201. The present application assembles the variable aperture 100 and the lens body 201 into a lens module 200, so that the lens module 200 can keep the blade group 4 fixed even when not energized, preventing abnormal noises of the lens module 200 caused by the movement of the blade group 4. In addition, it is possible to maintain the fixation of blade group 4 without the need for power, which also reduces the power loss of lens module 200.

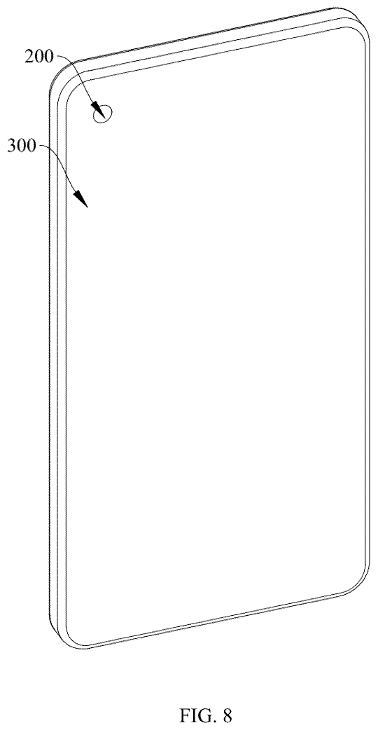

In a third aspect, please refer to FIG. 8, the present application also discloses an electronic device 300, including a lens module 200 as disclosed in the second aspect. Installing the lens module 200 onto the electronic device 300 can keep the blade group 4 in the variable aperture 100 fixed when the electronic device 300 is not energized, avoiding the occurrence of abnormal noise caused by the movement of the blade group 4. In addition, without using the lens module 200, the electronic device 300 can disconnect the power supply to the lens module 200. Keeping the blade group 4 in the variable aperture 100 fixed can also reduce the power loss of the electronic device 300, which is beneficial for the overall energy saving and consumption reduction of the electronic device 300.

Optionally, the electronic device 300 can be, but is not limited to, an electronic device with a camera such as a mobile phone, tablet or camera, and the present application does not make specific limitations here.

The above provides a detailed introduction of the variable aperture, lens module and electronic device disclosed in the embodiments of the present application. Specific examples are used herein to explain the principles and embodiments of the present application. The illustration of the above embodiments is only used to help understand the variable aperture, lens module, electronic device and their core ideas of this application. Meanwhile, for a person of ordinary skill in the art, there may be changes in the specific embodiments and application scope based on the thoughts of the present application. Therefore, the content of this specification should not be understood as limiting the present application.

What is claimed is:

1. A variable aperture, comprising:
a fixed seat, the fixed seat having a mounting space with an opening along an optical axis direction, the fixed seat being provided with a limiting portion along the optical axis direction, the limiting portion being located outside the mounting space to block at least a portion of a first opening of the mounting space;
a movable seat, the movable seat being provided movably in the mounting space, and the movable seat being provided with a light inlet along the optical axis direction;
a driving mechanism, the driving mechanism being provided at the fixed seat, and the driving mechanism being connected to the movable seat, the driving mechanism being configured to take the movable seat to rotate around the optical axis direction;
a blade group, the blade group being provided at one end of the movable seat towards the limiting portion and located in the mounting space, the blade group being rotates around the optical axis direction following the movable seat, wherein the blade group exposes or blocks at least a part of the light inlet to adjust the size of the light inlet; and
a retention assembly, the retention assembly comprising a first magnetic member and a second magnetic member, one of the first magnetic member and the second magnetic member being provided at the fixed seat, and the other of the two being provided at the movable seat, the first magnetic member and the second magnetic member being configured to magnetically connect the movable seat along the optical axis direction to the fixed seat, so that the blade group rests against the limiting portion.

2. The variable aperture of claim 1, wherein the variable aperture comprises a reset assembly, the reset assembly is provided in the mounting space, and the reset assembly is configured to drive the movable seat to reset relative to the fixed seat along the optical axis direction when energized, so that the blade group moves away from the limiting portion along the optical axis direction.

3. The variable aperture of claim 2, wherein the reset assembly comprises an electromagnetic coil and a third magnetic member, the electromagnetic coil is provided at the fixed seat, the third magnetic member is provided at the movable seat, and the electromagnetic coil is configured to generate a magnetic field when energized so that the third magnetic member responds to the acting force of the magnetic field to take the movable seat to reset relative to the fixed seat along the optical axis direction.

4. The variable aperture of claim 3, wherein the electromagnetic coil is provided on a surface of the fixed seat along a first direction, the third magnetic member is provided on a surface of the movable seat along the first direction, and the third magnetic member is provided corresponding at least partially to the electromagnetic coil;
wherein, the first direction is perpendicular to the optical axis direction.

5. The variable aperture of claim 1, wherein the retention assembly has multiple groups, and the multiple groups of the retention assembly are spaced separately around the optical axis of the variable aperture.

6. The variable aperture of claim 1, wherein the driving mechanism comprises a first mounting member, a second mounting member and a shape memory alloy wire, the first mounting member is provided at the fixed seat, the second mounting member is provided at the movable seat, the shape memory alloy wire connects the first mounting member to the second mounting member, and the shape memory alloy wire is configured to deform in response to temperature changes to take the movable seat to rotate around the optical axis direction.

7. The variable aperture of claim 1, wherein the fixed seat comprises a cover plate and a base, the cover plate is connected to the base and located outside the mounting space along the optical axis direction, the cover plate is formed as the limiting portion, and a second opening corresponding to and communicating with the light inlet is provided on the cover plate.

8. The variable aperture of claim 1, wherein the variable aperture comprises a sensor, the sensor is provided in the mounting space, and the sensor is configured to detect the rotational position of the movable seat relative to the fixed seat; and
the variable aperture comprises a housing and a flexible circuit board, the housing is provided on the outer peripheral surface of the fixed seat, the flexible circuit board is provided between the housing and the fixed seat, the sensor and the driving mechanism are electrically connected to the flexible circuit board, and the flexible circuit board is configured to be electrically connected to an electric circuit.

9. A lens module, comprising a lens body and a variable aperture as claimed in claim 1, and the variable aperture is connected to the lens body along the optical axis direction.

10. An electronic device, comprising a lens module as claimed in claim 9.
